(19) United States
(12) Patent Application Publication
(10) Pub. No.: US 2025/0179329 A1
(43) Pub. Date: Jun. 5, 2025

(54) FAST CURING AQUEOUS COATING COMPOSITIONS AND A METHOD OF COATING A SUBSTRATE USING THE SAME

(71) Applicant: BASF COATINGS GMBH, Muenster (DE)

(72) Inventors: Matthias GROSSE-DRENKPOHL, Muenster (DE); Stefanie SCHWEINS, Muenster (DE); Jens-Henning RUEMPEL, Muenster (DE); Karin REUTER, Muenster (DE)

(21) Appl. No.: 18/844,204

(22) PCT Filed: Apr. 3, 2023
(86) PCT No.: PCT/EP2023/058628

§ 371 Date: Sep. 5, 2024

(30) Foreign Application Priority Data
Apr. 6, 2022 (EP) 22166883.3

(51) Int. Cl. C09D 175/08

(52) U.S. Cl. CPC C09D 175/08

(57) ABSTRACT

Disclosed herein is an aqueous coating composition including three different aqueous dispersions, each aqueous dispersion including a different polyurethane resin, and a crosslinking agent. Despite the high amount of water present in the aqueous coating compositions, they result in fast curing times at room temperature, thus allowing to coat substrates requiring the use of fast curing aqueous coating compositions to comply with safety and environmental standards as well as with requirements within the production process. Further disclosed herein is a method for coating a substrate using the aqueous coating composition and a coating produced by the method. Also disclosed herein is a substrate bearing a coating produced by the method.

The present invention relates to an aqueous coating composition comprising three different aqueous dispersions, each aqueous dispersion comprising a different polyurethane resin, and a crosslinking agent. Despite the high amount of water present in the inventive aqueous coating compositions, they result in fast curing times at room temperature, thus allowing to coat substrates requiring the use of fast curing aqueous coating compositions to comply with safety and environmental standards as well as with requirements within the production process. Moreover, the present invention relates to a method for coating a substrate using the inventive coating composition and a coating produced by the inventive method. Finally, the present invention relates to a substrate bearing a coating produced by the inventive method.

### BACKGROUND OF THE INVENTION

Children's toys have a history dating back into antiquity. Plastic toys are usually produced by injecting molten polymer or plastic pellets into mold cavities having the desired shape. To obtain colored toys, pigments may be incorporated into the polymer melt prior to introduction into the mold cavities. After cooling, the solid toy or part of the toy is removed and optionally further hardened. In case the toy is manufactured from different pieces, said pieces are assembled to obtain the toy.

While the use of pigments in the polymer melt or the use of pigmented pellets allows to obtain colored toys or toy parts, said injection molding process results in toys and toy parts having a single uniform color and does not allow to produce toys and toy parts where specific areas are colored with at least one different color, such as plastic animal toys resembling real animals.

To achieve flexible coloring of toys and toy parts, coating compositions are used for coating the toys and toy parts after their production to provide the desired appearance. These coating compositions are applied onto the toys and toy parts obtained after injection molding to obtain the desired appearance.

Regardless of the type of coating used on a toy article, it has remained imperative that such coatings be safe for children. Safety requirements have evolved through the years as safety concerns have grown. Generally, safety requirements mandate that any material compositions used in a toy be odorless, nonirritating to the skin or eyes or the like, and be nontoxic if ingested. Additional requirements have been expected of compositions used to coat or paint toy articles in that they must be non-peeling, requiring that the coating or paint tenaciously adhere to the toy item to avoid flaking or peeling and possible consumption by a child user. And further the coating should be able to withstand physical influences occurring during the use of the toy so that the appearance of the coated surface is maintained. And above all the paint or coating composition must avoid the use of undesirable volatile organic solvents since the residual presence of said solvents in the coating can be dangerous due to the toxic effect of certain aromatic and chlorinated hydrocarbon solvents.

Especially in the manufacturing of toys, the degree of automation when it comes to applying a coating composition to the injection molded part is very low and a lot of manual processes, for example application of the coating, are still in use. For this reason, it is crucial to use a coating composition that allows short curing times at room temperature to ensure quick processing of the (partially) painted toy and toy part without damaging or smearing the formed coating layer. Such fast curing times are currently mostly ensured by the use of solvent-based coating compositions due to the fast evaporation of organic solvents at room temperature.

In view of the environmental, health and safety concerns in the use of organic solvents, toy paints or toy coating compositions comprising less controversial solvents such as water are desirable. However, water evaporates relatively slowly over a long period of time at room temperature, resulting in non-uniform and unstable coatings leaving these coating vulnerable to use factors which generate peeling and splitting among other negative consequences. Moreover, the use of elevated temperatures to accelerate the curing of aqueous coating compositions is not feasible because the plastic of the toy or toy part is prone to deformation and melting at these elevated temperatures, leading to a destruction or at least a negative influence in the appearance of the coated toy or toy part.

Thus, there is a need for aqueous coating compositions having short curing times, especially at room temperature, to allow quick processing of the coated plastic parts. Despite the high amount of water, the coating compositions should have good application properties and should not run even after application in high film thicknesses to avoid a negative influence on the appearance of the coated substrate. The resulting coating layer should have an excellent adhesion to a variety of substrates, in particular plastic substrates, to avoid peeling or splitting during use of the coated substrate and a sufficient hiding power to avoid recoating of the substrate.

### OBJECT

It is therefore an object of the present invention to provide an aqueous coating composition having excellent curing times at room temperature and resulting in coating layers showing excellent adhesion to a variety of substrates, in particular plastic substrates, as well as good optical properties. Despite the short curing times, the formed coating layer should not peel or split during mechanical stress and should have a high resistance against environmental influences, like solvents and UV irradiation. Additionally, the aqueous coating composition should be applicable with a variety of manual and automatic application methods and should not result in the formation of runs, even if applied in a high wet film thickness.

### Technical Solution

The objects described above are achieved by the subject matter claimed in the claims and also by the preferred embodiments of that subject matter that are described in the description hereinafter.

A first subject of the present invention is therefore an aqueous coating composition including:
(a) at least one aqueous dispersion D1 comprising a first polyurethane resin P1, said first polyurethane resin P1 having a glass transition temperature (Tg) of less than or equal to −30° C. as determined according to DIN EN ISO 11357-2-2020-08,
(b) at least one aqueous dispersion D2 comprising a second polyurethane resin P2 being different from the first polyurethane resin P1, said second polyurethane resin P2 having a 100% Modulus of at least 1 MPa as determined according to DIN 53504:2017-03,
(c) at least one aqueous dispersion D3 comprising a third polyurethane resin P3 being different from the first polyurethane resin P1 and the second polyurethane resin P2, said third polyurethane resin P3 having a glass transition temperature (Tg) of less than or equal to −40° C. as determined according to DIN EN ISO 11357-2-2020-08, and
(d) at least one crosslinking agent.

The above-specified aqueous coating composition is hereinafter also referred to as aqueous coating composition of the invention and accordingly is a subject of the present invention. Preferred embodiments of the aqueous coating composition of the invention are apparent from the description hereinafter and also from the dependent claims.

In light of the prior art it was surprising and unforeseeable for the skilled worker that the objects on which the invention is based could be achieved by an aqueous coating composition comprising three different polyurethane resins P1 to P3 and at least one crosslinking agent. Said aqueous coating compositions result in extremely fast curing times of less than 1 minute at room temperature when applied in a wet film thickness of up to 60 μm. The resulting coating layers show excellent adhesion to a variety of plastic substrates, such as PVC (polyvinyl chloride), TPE (thermoplastic elastomers), TPU (thermoplastic polyurethane), eTPU (expanded and expandable thermoplastic polyurethane), PA (polyamide) and PU (polyurethane), as well as natural substrates, such as wood. Despite the short curing times, the formed coating layer does not peel, split or change its color during mechanical stress or upon exposure to further environmental influences, such as solvents and UV irradiation. Additionally, the aqueous coating compositions are applicable with a variety of manual application method, such as dipping and brush application, and automatic application methods, such as spray application, and do not result in the formation of runs, even if applied in high wet film thicknesses. Moreover, the aqueous coating compositions result in coating layers having good optical properties, such as a good hiding power, thus avoiding recoating of the substrate to achieve the desired optical appearance.

A further subject of the present invention is a method for producing a coating (C) on a substrate (S), said method comprising a step of applying an inventive aqueous coating composition to the substrate (S) and a step of curing the applied coating composition.

Yet a further subject of the present invention is a coating produced by the inventive method.

A final subject of the present invention is a substrate (S) bearing an inventive coating (C).

### DETAILED DESCRIPTION

### Definitions

First of all, a number of terms used in the context of the present invention will be explained.

The grammatical articles “a”, “an”, and “the”, as used herein, are intended to include “at least one” or “one or more”, unless otherwise indicated, even if “at least one” or “one or more” is expressly used in certain instances. Thus, these articles are used in this specification to refer to one or more than one (i.e., to “at least one”) of the grammatical objects of the article. By way of example, and without limitation, “a component” means one or more components, and thus, possibly, more than one component is contemplated and may be employed or used in an implementation of the described embodiments. Further, the use of a singular noun includes the plural, and the use of a plural noun includes the singular, unless the context of the usage requires otherwise.

In this description of the invention, for convenience, “polymer” and “resin” are used interchangeably to encompass resins, oligomers, and polymers.

“Binder” in the context of the present invention and in accordance with DIN EN ISO 4618:2007-03 is the nonvolatile component of a coating composition, without pigments and fillers. Hereinafter, however, the expression is used principally in relation to particular physically and/or chemically curable polymers, examples being polyurethanes, polyesters, polyethers, polyureas, polyacrylates, polysiloxanes and/or copolymers of the stated polymers. The nonvolatile fraction may be determined according to DIN EN ISO 3251: 2018-07 at 130° C. for 60 min using a starting weight of 1.0 g.

As used herein, the term “aqueous coating composition” refers to a coating composition which comprises a water fraction of at least 20 wt. %, preferably at least 25 wt. %, very preferably at least 30 wt. %, based in each case on the total weight of the coating composition. The water fraction is preferably 25 to 60 wt. %, more particularly 30 to 70 wt. %, very preferably 30 to 60 wt. %, based in each case on the total weight of the coating composition. In contrast, the term “solvent-borne coating composition” refers to a coating composition with comprises a fraction of organic solvents of at least 20 wt. %, preferably at least 25 wt. %, very preferably at least 45 wt. %, based in each case on the total weight of the coating composition. The organic solvent fraction is preferably 40 to 70 wt. %, more particularly 45 to 65 wt. %, very preferably 50 to 60 wt. %, based in each case on the total weight of the coating composition.

“Room temperature” refers to temperatures of 15 to 25° C.

As used herein, the term “drying” of the applied coating composition refers to the evaporation of solvents from the applied coating composition. Drying can be performed at ambient temperature or by use of elevated temperatures. However, the drying does not result in a coating film being ready for use, i.e. a cured coating film as described below, because the coating film is still soft or tacky after drying.

Accordingly, “curing” of the applied coating composition or the coating film resulting from drying the applied coating composition refers to the conversion of such a composition or film into the ready-to-use state, i.e. into a state in which the substrate provided with the respective coating layer can be transported, stored and used as intended. More particularly, a cured coating layer is no longer soft or tacky, but has been conditioned as a solid coating layer which does not undergo any further significant change in its properties, such as hardness or adhesion to the substrate, even under further exposure to curing conditions. Curing can be performed at higher temperatures and/or for longer times than used for Drying of the applied coating composition.

The measurement methods to be employed in the context of the present invention for determining certain characteristic variables can be found in the Examples section. Unless explicitly indicated otherwise, these measurement methods are to be employed for determining the respective characteristic variable. Where reference is made in the context of the present invention to an official standard without any indication of the official period of validity, the reference is implicitly to that version of the standard that is valid on the filing date, or, in the absence of any valid version at that point in time, to the last valid version.

All film thicknesses reported in the context of the present invention should be understood as dry film thicknesses except explicitly stated otherwise. It is therefore the thickness of the cured film in each case. Hence, where it is reported that a coating material is applied at a particular film thickness, this means that the coating material is applied in such a way as to result in the stated film thickness after curing.

All temperatures elucidated in the context of the present invention should be understood as the temperature of the room in which the substrate or the coated substrate is located. It does not mean, therefore, that the substrate itself is required to have the temperature in question.

### Inventive Aqueous Coating Composition

### Aqueous Dispersion D1 Comprising a First Polyurethane Resin P1:

The inventive aqueous coating composition comprise, as a first mandatory component, at least one aqueous dispersion D1 comprising a first polyurethane resin P1. The first polyurethane resin P1 has a glass transition temperature (also denoted as T_{g} hereinafter) of less than or equal to −30° C. The glass transition temperature can be determined with DSC according to DIN EN ISO 11357-2-2020-08. Use of the aqueous dispersion D1, especially preferred embodiments of the aqueous dispersion D1 as outlined hereinafter, in combination with aqueous dispersions D2 and D3 ensures extremely fast curing times of the inventive aqueous coating composition at room temperature while at the same time resulting in excellent adhesion to a variety of plastic substrates as well as excellent optical properties and resistance against environmental influences.

In a preferred embodiment, the first polyurethane resin P1 has a glass transition temperature (Tg) of −30 to −50° C., preferably of −35° C. to −45° C., very preferably of −38° C. to −42° C.

The first polyurethane resin P1 is preferably an anionic polyurethane resin. The term “anionic polyurethane resin” refers to polyurethane resins containing anionic groups and/or groups which can be converted to anionic groups (potentially anionic groups), for example by neutralization with a suitable base. Said anionic groups can provide hydrophilic stabilization or increasing dispersibility in aqueous medium. Suitable anionic or potentially anionic groups include, for example, carboxylic acid, sulfonic acid and/or phosphonic acid groups or carboxylate, sulfonate and/or phosphonate groups. With preference, the anionic polyurethane resins contain carboxylic acid or carboxylate groups. The anionic modifications can be introduced into the polyurethane resin by means of monomers containing the anionic or potentially anionic groups as well as at least one group reactive toward isocyanate groups, preferably at least one hydroxyl group. The anionic polyurethane resin P1 can be neutralized with suitable neutralization agents, such as inorganic and organic bases, including aminoalcohols.

With particular preference, the first polyurethane resin P1 is an aliphatic polyester-based polyurethane resin. The term “polyester-based polyurethane resin” refers to to a polyurethane resin comprising polyester units, i.e. units comprising at least two ester groups. With preference, the polyester-based polyurethane resin comprises polyester units as main component, i.e. the polyester-based polyurethane resin is obtained by reacting at least one polyester polyol with a polyisocyanate compound. The polyester polyol may be obtained, for example, by reacting at least one polyol, such as a diol, with at least one acid, such as a polycarboxylic acid as described later on.

The first polyurethane resin P1 preferably has an acid number of 5 to 100 mg KOH/g solids, preferably of 10 to 50 mg KOH/g solids, very preferably of 15 to 30 mg KOH/g solids. The acid number can be determined by titration methods as described in DIN EN ISO 2114:2002-06 (procedure A). Introduction of the acid functionality allows to improve the water-dispersability of the first polyurethane resin P1 such that this resin can be stable introduced into an aqueous coating composition without requiring the use of organic solvents.

In an embodiment, the first polyurethane resin P1 has a hydroxyl number of 1 to 150 mg KOH/g solids, preferably of 2 to 100 mg KOH/solids, more preferably of 5 to 70 mg KOH/g solids, very preferably of 10 to 25 mg KOH/g solids. The hydroxyl number can be determined by titration methods as described in DIN EN ISO 2114:2002-06 (procedure A). The first polyurethane resin P1 is therefore preferably hydroxy-functional and can be cured using commonly known polyisocyanate crosslinking agents.

The first polyurethane resin P1 preferably has a number average molecular weight Mₙ of 750 to 2,000,000 g/mol, preferably of 1,000 to 1,000,000, more preferably of 2,000 to 500,000, very preferably of 5,000 to 10,000 g/mol. The number-average molecular weight Mₙ can be determined, for example, using GPC with polystyrene as internal standards.

The first polyurethane resin P1 is preferably obtained by reacting an NCO-functional prepolymer with at least one polyol as described for example in published DE 199 21 457 A1. The term “NCO-functional” refers to compounds comprising a free NCO-group or compounds comprising at least one blocked NCO-group which is blocked with a blocking agent known in the state of the art and can be unblocked, for example using heat, to generate a free NCO-group. The term “polyol” refers to compounds comprising at least two hydroxy groups.

The reaction of the NCO-functional prepolymer with the at least one polyol can be performed in the presence of customary and known organic solvents. The amount of organic solvents in this case may vary within wide limits, and ought to be sufficient to form a prepolymer solution with suitable viscosity. Generally speaking, up to 70 wt. %, preferably 5 to 50 wt. %, and more preferably less than 20 wt. % of solvents are used, based on the solids content. Accordingly, for example, the reaction may be carried out with very particular preference at a solvent content of 10-15 wt. %, based on the solids content. The reaction of the components may optionally take place in the presence of a catalyst, such as organotin compounds and/or tertiary amines. The organic solvents are removed after formation of the first polyurethane resin P1 as described later on to obtain aqueous dispersion D1.

Suitable equivalent ratios between the active hydrogen of the polyol and the NCO-groups of the NCO-functional prepolymer include 2:1 to 1:2, preferably 1.1:1 to 1:1.1.

The at least one polyol serves a modifier or chain extender. The modifier in that case is added preferably in an amount such that there are chain extensions and hence increases in molecular weight. Examples of polyols which can be used are trimethylolpropane, 1,3,4-butanetriol, glycerol, erythritol, mesoerythritol, arabitol, adonitol, etc. Preference is given to using an aliphatic monomeric polyol and more preferably an aliphatic monomeric polyol comprising at least three hydroxyl groups. “Aliphatic polyol” refers to polyols which are not aromatic. The aliphatic polyol may be saturated or unsaturated and may include heteroatoms (for example, oxygen nitrogen, sulfur). The heteroatoms may be present within bridging groups (such as ether linkages, ester linkages, urea linkages) and/or may be present within functional groups containing heteroatoms (for example hydroxy groups, amine groups, etc). “Monomeric” refers to compounds that is not formed by reacting at least two monomeric compounds with each other, i.e. that is not a polymeric compound. With particular preference, the polyol is trimethylol propane.

The NCO-functional prepolymer is preferably obtained by reacting:
at least one aliphatic polyester polyol having an OH number of 40 to 100 mg KOH/g solids and a number average molecular weight Mn of 1,000 to 3,000 g/mol,
at least one compound comprising at least one acid group and at least one group being capable of reacting with NCO-groups,
at least one polyol having an average molecular weight Mw of 60 to 400 g/mol, and
at least one polyisocyanate.

The reaction may be performed at temperatures of up to 150° C., preferably 50 to 130° C., in organic solvents which cannot react with isocyanates. Suitable equivalents ratios of NCO groups to OH groups are between 2.0:1.0 and >1.0:1.0, preferably between 1.4:1 and 1.1:1.

To obtain an NCO prepolymer of high flexibility, a high fraction of a predominantly linear polyester polyols having a preferred OH number of 30 to 150 mg KOH/g are preferably used. Up to 97 wt. % of the total polyester polyol may consist of saturated and unsaturated polyesters having a number-average molecular weight Mn of 400 to 5,000 g/mol. Suitable polyesterdiols can be prepared by esterification of organic dicarboxylic acids or their anhydrides with organic diols, or derived from a hydroxycarboxylic acid or a lactone. With particular preference, the aliphatic polyester polyol, in particular the aliphatic linear polyester polyol, is obtained by reacting a dimer fatty acid with an aromatic dicarboxylic acid and a diol. Dimer fatty acids (also long known as dimerized fatty acids or dimer acids) are generally, and especially in the context of the present invention, mixtures prepared by oligomerization of unsaturated fatty acids. They are preparable, for example, by catalytic dimerization of unsaturated plant fatty acids, with starting materials used more particularly being unsaturated C₁₂ to C₂₂ fatty acids. Linkage is primarily in accordance with the Diels-Alder type, and the result, depending on the number and position of the double bonds in the fatty acids used for preparing the dimer fatty acids, are mixtures of principally dimeric products, which have cycloaliphatic, linear aliphatic, branched aliphatic, and also Ce aromatic hydrocarbon groups between the carboxyl groups. Depending on mechanism and/or optionally subsequent hydrogenation, the aliphatic radicals may be saturated or unsaturated and the fraction of aromatic groups as well may vary. The radicals between the carboxylic acid groups then contain, for example, 24 to 44 carbon atoms. For the preparation, fatty acids having 18 carbon atoms are preferably used, and so the dimeric product has 36 carbon atoms. The radicals which join the carboxyl groups of the dimer fatty acids preferably have no unsaturated bonds and no aromatic hydrocarbon radicals. Preferred dimer fatty acids are dimer fatty acids obtained from using C₁₈ fatty acids, such as linolenic, linoleic and/or oleic acid, as starting materials.

Besides the polyester polyol, at least one compound comprising at least one acid group and at least one group being capable of reacting with NCO-groups of the NCO-functional prepolymer is used. Such compounds include alkanoic acids having 3 to 8 carbon atoms and 2 hydroxy groups. These compounds preferably make up to 3 to 100 wt. %, preferably up to 5 to 50 wt. %, of the entire polyol constituent in the NCO-functional prepolymer. A particularly preferred compound is dimethylol propionic acid. The amount of ionizable carboxyl groups that is available through the carboxyl group neutralization in salt form is at least 0.4 wt. %, preferably at least 0.7 wt. %, based on the solids of the NCO-functional prepolymer. The dihydroxyalkanoic acids in the unneutralized prepolymer are preferably used in amounts which result in the aforementioned acid numbers.

Polyols having an average molecular weight MW of 60 to 400 g/mol are preferably selected from aliphatic polyols having 3 to 10 carbon atoms and 2 hydroxy groups. Said polyols do preferably not contain carboxyl, sulfonic acid and/or phosphonic acid groups and are preferably selected from diols of the formula (1)

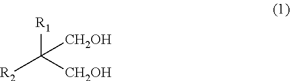

in which R₁ and R₂ each represent an identical or different radical and are an alkyl radical having 1 to 18 carbon atoms, an aryl radical or a cycloaliphatic radical. Particularly preferred diols of the formula (1) are diols in which R₁ and R₂ are each a methyl radical (i.e. neopentyl glycol). The diols of formula (1) are used customarily in an amount of 0.1 to 15 wt. %, preferably of 0.5 to 5 wt. %, based in each case on the total weight of the components used to prepare the NCO-functional prepolymer.

Typical polyfunctional isocyanates used for preparing the NCO-functional prepolymer are aliphatic, cycloaliphatic and/or aromatic polyisocyanates having at least two isocyanate groups per molecule, in particular cycloaliphatic polyisocyanates. The isomers or isomer mixtures of organic diisocyanates are preferred. On account of their high stability toward ultraviolet light, (cyclo)aliphatic diisocyanates give rise to products with little yellowing tendency. The polyisocyanate component used to form the NCO-functional prepolymer may also include a fraction of polyisocyanates of higher functionality, provided that this does not cause any gelling. Established triisocyanates are products formed by trimerization or oligomerization of diisocyanates or by reaction of diisocyanates with polyfunctional compounds containing OH or NH groups. The average functionality 10 may optionally be lowered by addition of monoisocyanates.

Examples of polyisocyanates which can be used are phenylene diisocyanate, tolylene diisocyanate, xylylene diisocyanate, bisphenylene diisocyanate, naphthylene diisocyanate, diphenylmethane diisocyanate, isophorone diisocyanate, cyclobutane diisocyanate, cyclopentylene diisocyanate, cyclohexylene diisocyanate, methylcyclohexylene diisocyanate, dicyclohexylmethane diisocyanate, ethylene diisocyanate, trimethylene diisocyanate, tetramethylene diisocyanate, pentamethylene diisocyanate, hexamethylene diisocyanate, propylene diisocyanate, ethylethylene diisocyanate, and trimethylhexane diisocyanate.

For producing high-solids, anionically stabilized aqueous dispersion D1, use is made in particular of diisocyanates of general formula (2)

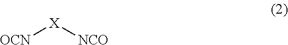

where X is a divalent cyclic and optionally aromatic hydrocarbon radical, preferably an optionally halogen-, methyl or methoxy-substituted dicyclohexylmethyl, naphthylene, diphenylene or 1,2-, 1,3- or 1,4-phenylene radical, more preferably a dicyclohexylmethyl radical. One diisocyanate of the formula (2) that is used with particular preference in the context of the present invention is 4,4′-methylenedicyclohexyl diisocyanate (also referred to as H₁₂MDI).

The NCO-functional prepolymer contains at least 0.5 w.t % of isocyanate groups, preferably at least 1 wt. % of isocyanate groups, based on the solids. The upper limit is 15 wt. %, preferably 10 wt. %, more preferably 5 wt. % of isocyanate groups.

With particular preference, the NCO prepolymer is obtainable by reaction of
I. 55 to 70 wt. %, based on the total weight of the compounds (I) to (IV), of at least one polyester polyol having an OH number of 40 to 100 mg KOH/g solids and a number-average molecular weight Mn of 1,000 to 3,000 g/mol, in particular a polyester polyol prepared by reacting a dimer fatty acid with an aromatic dicarboxylic acid and a diol,
II. 3 to 7 wt. %, based on the total weight of the compounds (I) to (IV), of at least one alkanoic acid having 3 to 8 carbon atoms and also two hydroxyl groups on the alpha carbon atom, especially dimethylolpropionic acid,
III. 0.5 to 3 wt. %, based on the total weight of the compounds (I) to (IV), of at least one polyol of the formula (1) where R₁=R₂=methyl, and
IV. 25 to 30 wt. %, based on the total weight of the compounds (I) to (IV), of at least one diisocyanate of the formula (2) where X=dicyclohexylmethyl radical.

The organic solvent used for the synthesis of the polyurethane resin P1 is preferably removed after addition of water under reduced pressure to obtain the aqueous dispersion D1. The anionically stabilized polyurethane resin P1 is preferably neutralized with a base, preferably with an organic base, more particularly with N,N′-dimethylethanolamine, the base being added in an amount such that a degree of neutralization of 50% to 100%, preferably of 60% to 80%, is achieved. As a result of the addition of the base, the dispersion has a pH of 7 to 8.

To facilitate the dispersing of the partially neutralized anionically stabilized polyurethane resin P1 in water, an alkylene glycol, preferably propylene glycol having an average molar mass Mn of 800 to 1,500 g/mol, is added. Apart from the alkylene glycol, the aqueous dispersion D1 preferably only comprises water and the first polyurethane resin P1, i.e. the first aqueous dispersion D1 is preferably free of organic solvents (i.e. the total amount of organic solvents in dispersion D1 is less than 1% by weight, based on the total weight of the dispersion D1).

The aqueous dispersion D1 preferably has an average particle size (z-mean) of 30 to 200 nm, preferably of 40 to 100 nm, very preferably of 45 to 60 nm, determined according to photon correlation spectroscopy.

The aqueous dispersion D1 preferably comprises the first polyurethane resin P1 in a total amount of 10 to 60% by weight, preferably of 15 to 50% by weight, more preferably of 20 to 40% by weight, very preferably of 25 to 35% by weight, based in each case on the total weight of the aqueous dispersion D1. Use of high solids aqueous dispersions having low viscosities despite their high amounts of solids is preferred with respect to achieving extremely fast curing times of the aqueous coating composition at room temperature.

In an embodiment, the aqueous coating composition comprises the aqueous dispersion D1 in a total amount of 5 to 60% by weight, preferably of 10 to 50% by weight, very preferably of 15 to 25% by weight, based in each case on the total weight of the aqueous coating composition. Use of the aforementioned amounts of aqueous dispersion D1, in combination with aqueous dispersions D2 and D3 ensures the extremely fast curing times of the inventive aqueous coating composition at room temperature while at the same time resulting in excellent adhesion to a variety of plastic substrates as well as excellent optical properties and a high resistance against environmental influences, such as solvents, abrasion and UV irradiation.

### Aqueous Dispersion D2 Comprising a Second Polyurethane Resin P2:

As second mandatory ingredient, the aqueous coating composition comprises an aqueous dispersion D2 comprising a second polyurethane resin P2. The second polyurethane resin P2 is different from the first polyurethane resin P1 described in detail above and has a 100% Modulus of at least 1 MPa as determined according to DIN 53504:2017-03. The term “modulus” refers to the force at a specific elongation value and is typically expressed in pounds per square inch (psi) or megapascals (MPa). The term “100% Modulus” refers to the modulus at 100% elongation. Use of the aqueous dispersion D2, in combination with aqueous dispersions D1 and D3 ensures the extremely fast curing times of the inventive aqueous coating composition at room temperature while at the same time resulting in excellent adhesion to a variety of plastic substrates as well as excellent optical properties and resistance against environmental influences.

According to a preferred embodiment, the second polyurethane resin P2 has a 100% Modulus of 1 to 6 MPa, preferably of 1 to 4 MPa, very preferably of 1.4 to 1.9 MPa, as determined according to DIN 53504:2017-03.

The second polyurethane resin P2 preferably has a tensile strength of 10 to 50 MPa, preferably of 15 to 40 MPa, very preferably of 22 to 28 MPa, as determined according to DIN 53504:2017-03.

Suitable second polyurethane resins P2 include polyurethane resins having an elongation at break of 400 to 1,500%, preferably of 600 to 900%, very preferably of 720 to 780%, as determined according to DIN 53504:2017-03.

In an embodiment, the second polyurethane resin P2 has a melting range of 150 to 300° C., preferably of 190 to 230° C. “Melting range” refers to the span of temperature from the point at which the crystals first begin to liquefy to the point at which the entire sample is liquid. The melting range is preferably determined using a Kofler heating table.

The 100% Modulus, the tensile strength, the elongation at break and the melting range of polyurethane resin P2 can be determined using approximately 0.1 mm transparent films of said polymer which are thickened with 2% Borchi® Gel ALA (supplied by OMG Borchers).

The second polyurethane resin P2 is preferably an anionic polyurethane resin. The anionic resin may be neutralized with organic bases, such as the organic bases previously described, to facilitate dispersion in water.

The second polyurethane resin P2 is preferably an aliphatic polycarbonate-polyether-based polyurethane resin. The term “polycarbonate-polyether-based polyurethane resin” refers to a polyurethane resin comprising polycarbonate units as well as polyether units. The polycarbonate units are units comprising at least two carbonate groups in their structure. Such groups can be formed, for example, by condensation-polymerization of a diol with a carbonate precursor such as a phosgene. Polyether units are units comprising at least two ether groups and can be formed, for example, by catalytic polymerization of epoxides. Use of an anionic polycarbonate-polyether-based polyurethane resin results in a higher water dispersability and thus allows to incorporate said polyurethane resin P2 into aqueous dispersions without the additional use of undesired organic solvents. A suitable aqueous dispersion includes the commercial anionic aliphatic polycarbonate-polyester-based polyurethane dispersion Impranil DLV/1 available from Covestro Deutschland AG.

The aqueous dispersion D2 preferably comprises the second polyurethane resin P2 in a total amount of 10 to 70% by weight, preferably of 15 to 60% by weight, more preferably of 25 to 50% by weight, very preferably of 35 to 45% by weight, based in each case on the total weight of the aqueous dispersion D2. Use of high solids aqueous dispersions having low viscosities despite their high amounts of solids is preferred with respect to achieving extremely fast curing times of the aqueous coating composition at room temperature.

In an embodiment, the aqueous coating composition comprises the aqueous dispersion D2 in a total amount of 5 to 60% by weight, preferably of 10 to 50% by weight, very preferably of 20 to 35% by weight, based in each case on the total weight of the aqueous coating composition. Use of the aforementioned amounts of dispersion D2, in combination with aqueous dispersions D1 and D3 ensures the extremely fast curing times of the inventive aqueous coating composition at room temperature while at the same time resulting in excellent adhesion to a variety of plastic substrates as well as excellent optical properties and a high resistance against environmental influences, such as solvents, abrasion and UV irradiation.

### Aqueous Dispersion D3 Comprising a Third Polyurethane Resin P3:

As third mandatory ingredient, the aqueous coating composition comprises an aqueous dispersion D3 comprising a third polyurethane resin P3. The third polyurethane resin P3 is different from the first polyurethane resin P1 and the second polyurethane resin P2 described in detail above and has a glass transition temperature (Tg) of less than or equal to −40° C. Use of the aqueous dispersion D3, in combination with aqueous dispersions D1 and D2 ensures the extremely fast curing times of the inventive aqueous coating composition at room temperature while at the same time resulting in excellent adhesion to a variety of plastic substrates as well as excellent optical properties and resistance against environmental influences.

Preferred third polyurethane resins P3 have a glass transition temperature (Tg) of −40 to −80° C., preferably of −40° C. to −60° C., very preferably of −42° C. to −55° C.

The third polyurethane resin P3 is preferably an anionic polyurethane resin. The anionic resin may be neutralized with organic bases, such as the organic bases previously described above, to facilitate dispersion of the polyurethane resin in water. With particular preference, the third polyurethane resin P3 is an aliphatic polycarbonate-polyester-based polyurethane resin. The term “polycarbonate-polyester-based polyurethane resin” refers to a polyurethane resin comprising polycarbonate units as well as polyester units. The polycarbonate units are units comprising at least two carbonate groups in their structure. Such groups can be formed, for example, by condensation-polymerization of a diol with a carbonate precursor such as a phosgene. Polyester units are units comprising at least two ester groups and can be formed, for example, by reaction of polyols, such as diols, with polyacids, such as dicarboxylic acids. Use of an anionic polycarbonate-polyester-based polyurethane resin results in a higher water dispersability and thus allows to incorporate said polyurethane resin P3 into aqueous dispersions without the additional use of undesired organic solvents.

In an embodiment, the aqueous dispersion D3 has an average particle size (z-mean) of 20 to 200 nm, preferably of 30 to 100 nm, very preferably of 40 to 80 nm, determined according to photon correlation spectroscopy. A suitable aqueous dispersion includes the commercial anionic aliphatic polycarbonate-polyether-based polyurethane dispersion Bayhydrol UH 2648/1 available from Covestro Deutschland AG.

The aqueous dispersion D3 comprises the third polyurethane resin P3 in a total amount of 10 to 60% by weight, preferably of 20 to 50% by weight, very preferably of 30 to 40% by weight, based in each case on the total weight of the aqueous dispersion D3. Use of high solids aqueous dispersions having low viscosities despite their high amounts of solids is preferred with respect to achieving extremely fast curing times of the aqueous coating composition at room temperature.

In embodiment, the aqueous coating composition comprises the aqueous dispersion D3 in a total amount of 1 to 40% by weight, preferably of 5 to 30% by weight, very preferably of 8 to 20% by weight, based in each case on the total weight of the aqueous coating composition. Use of the aforementioned amounts of dispersion D3, in combination with aqueous dispersions D1 and D2 ensures the extremely fast curing times of the inventive aqueous coating composition at room temperature while at the same time resulting in excellent adhesion to a variety of plastic substrates as well as excellent optical properties and a high resistance against environmental influences, such as solvents, abrasion and UV irradiation.

### Crosslinking Agent:

As fourth mandatory ingredient, the aqueous coating composition comprises at least one crosslinking agent. “Crosslinking agent” refers to compounds, in particular organic compounds, which contain reactive functional groups which are complementary to the reactive functional groups present in first polyurethane resin P1 and/or the second polyurethane resin P2 and/or in the third polyurethane resin P3. Crosslinking of the polyurethane resins P1 to P3 with at least one crosslinking agent results in a cured coating layer having a high adhesion to a variety of plastic substrates, thus avoiding peeling and splitting of the cured coating layer from the plastic substrate upon use. Moreover, the crosslinking prevents release of substances, such as pigments, from the formed coating layer, thus avoiding a negative influence on the health arising from said released substances.

The crosslinking agent is preferably selected from amino resins, unblocked polyisocyanates, at least partially blocked polyisocyanates, polycarbodiimides and mixtures thereof. Unblocked polyisocyanates refers to polyisocyanates containing free NCO groups while the term “blocked polyisocyanates” refers to polyisocyanates comprising at least one NCO group being blocked with a blocking agent commonly used in the state of the art. Unblocking of the NCO group(s) can be facilitated, for example, by heating the coating composition, for example during the curing process.

With particular preference, the at least one crosslinking agent is selected from unblocked polyisocyanates. The unblocked polyisocyanates are preferably selected from hexamethylene diisocyanate, octamethylene diisocyanate, decamethylene diisocyanate, dodecamethylene diisocyanate, tetradecamethylene diisocyanate, trimethylhexane diisocyanate, tetra-methylhexane diisocyanate, isophorone diisocyanate (IPDI), 2-isocyanatopropylcyclohexyl isocyanate, dicyclo-hexylmethane 2,4′-diisocyanate, dicyclohexyl-methane 4,4′-diisocyanate, 1,4- or 1,3-bis(isocyanato-methyl)cyclohexane, 1,4- or 1,3- or 1,2-diisocyanato-cyclohexane, and 2,4- or 2,6-diisocyanato-1-methyl-cyclo-hexane, the dimers, trimers and tetramers thereof, and also mixtures of these polyisocyanates. With particular preference the polyisocyanate comprises aliphatic and/or cycloaliphatic, very preferably aliphatic, polyisocyanates. Serving as a diisocyanate basis for the aforementioned oligomers, more particularly the aforementioned trimers or tetramers, is very preferably hexamethylene diisocyanate and/or isophorone diisocyanate, and especially preferably just hexamethylene diisocyanate.

In this context it is particularly preferred if the polyisocyanate possesses an NCO group functionality of greater than 2.4 to 5, preferably 2.6 to 4, more preferably 2.8 to 3.6.

Employed with particular preference in the context of the present invention are polyisocyanates which comprise at least one isocyanurate ring or at least one iminooxadiazinedione ring.

It may be preferred if at least two polyisocyanates different from one another are used as crosslinking agent, with the first polyisocyanate comprising at least one isocyanurate ring and the second polyisocyanate comprising at least one iminooxadiazinedione ring. Use of said mixture of crosslinking crosslinking agents results in a high adhesion of the cured coating layer on a variety of plastic substrates, thus avoiding peeling and splitting of the cured coating layer during use of the coated substrate.

In one embodiment, the aqueous coating composition comprises the at least one crosslinking agent in a total amount of 1 wt. % to 40 wt. % solids, preferably of 2 to 30 wt. % solids, more particularly of 6 to 12 wt. % or 15 to 25 wt. % solids, based in each case on the total weight of the aqueous coating composition. Use of said amounts results in sufficient crosslinking of the coating layer during curing, thus allowing to obtain an excellent adhesion on a variety of plastic substrates as well as a good abrasion resistance of the cured coating layer.

Depending on the particular crosslinking agent(s) present in the composition of the invention, the composition of the invention is configured as a one-component system or is obtainable by mixing two (two-component system) or more (multicomponent system) components. In thermochemically curable one-component systems, the components to be crosslinked, in other words polyurethane resins P1 to P3 and optionally further binders and crosslinking agent(s), are present alongside one another, in other words in one component. A condition for this is that the components to be crosslinked react with one another effectively only at relatively high temperatures, of more than 100° C., for example, so as to prevent premature at least proportional thermochemical curing. Such a combination may be exemplified by hydroxy-functional polyesters and/or polyurethanes with melamine resins and/or blocked polyisocyanates as crosslinking agents.

In thermochemically curable two-component or multicomponent systems, the components to be crosslinked, in other words polyurethane resins P1 to P3 and optionally further binders and crosslinking agent(s), are present separately from one another in at least two components, which are not combined until shortly before the application. This form is selected when the components to be crosslinked react with one another effectively even at ambient temperatures or slightly elevated temperatures of, for example, 40 to 90° C. Such a combination may be exemplified by hydroxy-functional polyesters and/or polyurethanes and/or poly(meth)acrylates with free polyisocyanates as crosslinking agents. According to a preferred embodiment of the invention, the aqueous coating compositions are formulated as two-component or multi-component aqueous coating composition and are prepared by mixing a base component comprising the aqueous dispersions D1 to D3 and optionally further ingredients mentioned below with a hardener component comprising the crosslinking agents dissolved in at least one solvent and optionally a base color component. A “hardener component” in the context of the present invention is a material comprising at least one crosslinking component being capable of reacting with functional chemical groups being present in the polyurethane resins P1 to P3 and optionally further polymers of the base component. Mixing of said components prior to application may be performed using commonly known mixing methods.

Where the composition of the invention is obtainable by mixing two components, the weight ratio of the base component comprising aqueous dispersions D1 to D3 and optionally further ingredients listed below to the hardener component comprising the at least one crosslinking agent is preferably from 100:1 to 100:50, more preferably from 100:2 to 100:30, more particularly from 100:3 to 100:7. The use of the above-described mixing ratios ensures sufficient crosslinking of the aqueous coating composition upon curing and provides high adhesion to the surface of the plastic substrate.

### Further Ingredients:

Apart from the mandatory ingredients mentioned above, the aqueous coating composition can further comprise additional ingredients. Suitable further ingredients include at least polymer being different from polyurethane resins P1 to P3, color and/or effect pigment(s), matting agents, thickening agents, dispersing agents, leveling agents, pH adjustment agents, defoaming agents, biocides, UV absorbers, crosslinking catalysts and mixtures thereof.

Examples of further polymers include further polyurethane resins being different from polyurethane resins P1 to P3.

The aqueous coating composition of the invention can further comprise at least one color and/or effect pigment to achieve a colored coating layer. The color and/or effect pigment can be introduced into the aqueous coating composition by mixing the aqueous dispersions D1 to D3 and optionally further ingredients with at least one color base component. The term “color base component” here means a colorant composition having a precisely defined color. Use of at least one color base component allows to achieve a colored coating layer having a high accuracy of color, i.e. the color of the resulting coating layer matches the color to be expected from using the respective color base component(s). Moreover, a high color diversity is possible, since color base components are existing in a large variety of colors and said color base components can be mixed with one another in order to obtain further color shades.

The at least one color base component comprises at least one effect pigment and/or at least one coloring pigment.

Effect pigments are pigments which are able to produce a decorative effect in coatings and additionally, but not exclusively, to produce a coloring effect. The effect pigments are notable in particular for a plateletlike construction. Preferred effect pigments are, for example, platelet-shaped metallic effect pigments such as platelet-shaped aluminum pigments, gold bronzes, oxidized bronzes and/or iron oxide-aluminum pigments, pearlescent pigments and/or metal oxide-mica pigments, and/or other effect pigments such as platelet-shaped graphite, platelet-shaped iron oxide, multilayer effect pigments composed of PVD films, and/or liquid crystal polymer pigments. Particularly preferred are platelet-shaped metallic effect pigments, more particularly platelet-shaped aluminum pigments and/or coated metal oxide-mica pigments and/or borosilicates coated with metal oxides.

Examples of inorganic coloring pigments are white pigments such as titanium dioxide; black pigments such as carbon black, iron manganese black or spinel black; chromatic pigments such as ultramarine green, ultramarine blue or manganese blue, ultramarine violet or manganese violet, red iron oxide, molybdate red or ultramarine red; brown iron oxide, mixed brown, phases of spinel and corundum; or yellow iron oxide or bismuth vanadate. Examples of suitable organic coloring pigments are monoazo pigments, disazo pigments, anthraquinone pigments, benzimidazole pigments, quinacridone pigments, quinophthalone pigments, diketopyrrolopyrrole pigments, dioxazine pigments, indanthrone pigments, isoindoline pigments, isoindolinone pigments, azomethine pigments, thioindigo pigments, metal complex pigments, perinone pigments, perylene pigments, phthalocyanine pigments or aniline black.

The at least one effect pigment and/or the at least one coloring pigment are present preferably in a total amount of 0.5 to 70 wt. %, based on the total weight of the color base component.

The color base component may also comprise at least one binder. This binder serves for stable dispersing of the pigment and in that way ensures high intensity of color and high color homogeneity of the color base component. Suitable binders include polyurethane polymers, more particularly anionically stabilized polyurethane polymers, for example the anionic first polyurethane resin P1. Use of polyurethane resins P1 and/or P2 and/or P3, such as the first polyurethane resin P1, within the color base component avoids incompatibilities upon mixing the color base component with further components of the aqueous coating composition. The at least one binder, more particularly the aforesaid anionically stabilized polyurethane resin P1, is present preferably in an amount of 10 to 80 wt %, based on the total weight of the color base component.

The color base component may also comprise at least one solvent. Solvents which can be used are water, commonly known organic solvents and mixtures thereof. Employed with particular preference is a mixture of water and butyl glycol and/or methyl ethyl ketone.

Preferred color base components each comprise—based on their total weight—
0.5 to 70 wt. % of at least one effect pigment and/or at least one coloring pigment,
10 to 80 wt. % of at least one binder selected from the group of polyurethane polymers, amino resin polymers, polyacrylate polymers, polyester polymers, and mixtures thereof, more particularly an above-recited anionically stabilized polyurethane resin P1, and
at least one organic solvent.

With particular preference, the color base component does not contain large amounts of organic solvents, i.e. is a low VOC color base component having a VOC of less than 250 g/L. Suitable low VOC color base component for use within the present invention include the color base components disclosed in published applications WO 2021/018595 A1 and WO 2021/018594 A1.

Suitable matting agents are for example silicon dioxide, which is adjusted to the necessary particle size for the corresponding coating. Alternatively, urea-methanal condensates or mixtures based on polyamide-12 can also be used.

Suitable thickeners include inorganic thickeners and/or organic thickeners. Examples of inorganic thickeners are inorganic thickeners from the group of the phyllosilicates, such as lithium aluminum magnesium silicates. Organic thickeners are preferably selected from the group consisting of (meth)acrylic acid-(meth)acrylate copolymer thickeners, for example the commercial product Rheovis® AS 1130 (BASF SE), and of polyurethane thickeners, for example the commercial product Rheovis® PU 1250 from BASF SE. (Meth)acrylic acid-(meth)acrylate copolymer thickeners are those which as well as acrylic acid and/or methacrylic acid also contain in copolymerized form one or more acrylic esters (i.e., acrylates) and/or one or more methacrylic esters (i.e., methacrylates). A feature common to the (meth)acrylic acid-(meth)acrylate copolymer thickeners is that in an alkaline medium, in other words at pH levels >7, more particularly >7.5, by formation of a salt of the acrylic acid and/or methacrylic acid, in other words by the formation of carboxylate groups, they exhibit a strong increase in viscosity. If (meth)acrylic esters are used which are formed from (meth)acrylic acid and a C₁-C₆ alkanol, the products are essentially nonassociative (meth)acrylic acid-(meth)acrylate copolymer thickeners, such as the abovementioned Rheovis AS 1130, for example. Essentially nonassociative (meth)acrylic acid-(meth)acrylate copolymer thickeners are also referred to in the literature as ASE thickeners (“Alkali Soluble/Swellable Emulsion” or dispersion). Also possible for use as (meth)acrylic acid-(meth)acrylate copolymer thickeners, however, are those known as HASE thickeners (“Hydrophobically Modified Anionic Soluble Emulsions” or dispersion). These are obtained by using as alkanols, instead of or in addition to the C₁-C₆ alkanols, those having a larger number of carbon atoms, as for example 7 to 30, or 8 to 20 carbon atoms. HASE thickeners have an essentially associative thickening effect. On account of their thickening properties, the (meth)acrylic acid-(meth)acrylate copolymer thickeners which can be used are not suitable as binder resins, and hence do not come under the physically, thermally, or both thermally and actinically curable binders that are identified as binders, and they are therefore explicitly different from the poly(meth)acrylate-based binders which can be employed in the basecoat material compositions of the invention. Polyurethane thickeners are the associative thickeners that are identified in the literature as HEUR (“Hydrophobically Modified Ethylene Oxide Urethane Rheology Modifiers”). Chemically these are nonionic, branched or unbranched, block copolymers composed of polyethylene oxide chains (sometimes also polypropylene oxide chains) which are linked to one another via urethane bonds and which carry terminal long-chain alkyl or alkylene groups having 8 to 30 carbon atoms. Typical alkyl groups are, for example, dodecyl or stearyl groups; a typical alkenyl group is, for example, an oleyl group; a typical aryl group is the phenyl group; and a typical alkylated aryl group is, for example, a nonylphenyl group. On account of their thickening properties and structure, the polyurethane thickeners are not suitable as binder resins curable physically, thermally, or both thermally and physically. They are therefore explicitly different from the polyurethanes which can be used as binders in the basecoat material compositions of the invention.

The at least one additive is present preferably in a total amount of 0 wt. % to 10 wt. %, based on the total weight of the aqueous coating composition.

### Properties of the Inventive Aqueous Coating Compositions:

The aqueous coating composition preferably has a high solids content to reduce the curing time necessary to achieve a sufficiently cured coating layer at room temperature. Preferred solids contents include 10 to 70 wt. %, preferably 20 to 65 wt. %, in particular 35 to 55 wt. %, based in each case on the total weight of the aqueous coating composition.

Despite the high solid content, the aqueous coating composition preferably has a low viscosity to allow application of the aqueous coating composition using commonly known application methods. With preference, the aqueous coating composition has a viscosity of 10 to 1,000 mPa*s, preferably 40 to 600 mPa*s, in particular 100 to 250 mPa*s, as determined according to DIN EN ISO 3219-1994-10.

The aqueous coating composition preferably comprises a VOC of 10 to 100 g/L, preferably of 10 to 60 g/L. The VOC value is defined as follows: VOC (g/L)=(total weight of volatile components (g)−total weight of water (g))/(volume of coating agent (L)−volume of water (L)). Volatile components are compounds which have a vapor pressure of more than 10 Pascal at processing temperature, in particular at 20° C. (cf. 31st BlmSchV and corresponding VOC directives and VOC regulations of the EU). In addition, volatile components are understood to be organic compounds which have an initial boiling point of less than or equal to 250° C. at a standard pressure of 101.3 kPa (cf. Directive 2004/42/EC of the European Parliament and of the Council). Due to the low amounts of organic solvents, the inventive aqueous coating compositions fulfill the strict safety requirements associated with toys, thus rendering said aqueous coating compositions especially suitable for coating of toys and toy parts.

### Process for Preparing Inventive Aqueous Coating Compositions:

The inventive aqueous coating compositions can be prepared by introducing all ingredients into a respective container and mixing the ingredients using commonly known mixing equipment. If the aqueous coating composition is a 2K coating composition as described above, the base component comprising aqueous dispersions D1 to D3 and optionally further ingredient(s) described previously and the hardener component comprising the at least one crosslinking agent are prepared separately and are mixed shortly before application onto the substrate.

According to a preferred embodiment, the aqueous coating composition is a 3K composition and is prepared by mixing a base component comprising the aqueous dispersions D1 to D3 and optionally further ingredient(s) listed above with at least one base color component and a hardener component. Suitable weight ratios of the base component to the color base component(s) to the hardener component include 100:1:1 to 1:100:50 or 80:80:2 to 20:80:20 or 60:60:4 to 40:40:10. In case more than one color base component is used, the aforementioned weight ratio refers to the sum of all color base components used during the production of the inventive aqueous coating composition.

Mixing of the components may take place manually, with the appropriate amount of a base component being introduced into a vessel, admixed with the corresponding quantity of the base color component and the hardener component. The order of introduction of the components into the vessel can also be varied such that, for example, the base component and the base color component is introduced into the vessel and admixed with the corresponding quantity of the hardener component. However, mixing of the two or more components can also be performed automatically by means of an automatic mixing system. Such an automatic mixing system can comprise a mixing unit, more particularly a static mixer, and also at least three devices for supplying the polyurethane resins containing base component, the color base component and the crosslinking agent containing hardener component, more particularly gear pumps and/or pressure valves. Both in the case of manual mixing and in the case of the supply of the components for automatic mixing, the separate components preferably each possess temperatures of 15 to 70° C., more preferably 15 to 40° C., more particularly 20 to 30° C.

### Inventive Coating Method

According to the inventive method, a coating (C) is produced on a substrate (S), by applying the inventive aqueous coating composition to said substrate (S) and curing the applied coating composition to form the coating (C).

The substrate may be selected from metal substrates, plastic substrates, substrates comprising metal and plastic parts, wood or paper. With particular preference, the substrate is selected from plastic substrates.

Suitable plastic substrates include (i) thermoplastics, such as polyolefins, thermoplastic polyurethane (TPU), thermoplastic rubbers (TPE), poly(meth)acrylates (PA), polystyrene, polyvinyl chloride (PVC), polyamides, polyurethanes, polycarbonates, polylactic acid (PLA), saturated polyesters like PET (polyethylene terephthalate), ethylene-propylene-diene (EPDM), acrylonitrile-styrene-butadiene (ABS), vinyl polymers selected from halogenated polymers other than PVC, (ii) thermosets, such as phenol resins, epoxy resins, unsaturated poly ester resins, resins with furanic groups, resins with urea groups, melamine resins, poly urethane resins (PUs), (iii) mixtures of the aforementioned thermoplastics and thermosets, (iv) fiber-reinforced polymers or composites derived from the above-cited thermoplastics or thermosets. With particular preference, the substrate is a thermoplastic rubber substrate, such as a molded thermoplastic toy or a part thereof.

### Application of Inventive Aqueous Coating Composition to Substrate:

In the first step of the inventive method, the inventive aqueous coating composition is applied to the substrate, in particular to at least part of the surface of the substrate. The application of an aqueous coating composition to at least part of the surface of a substrate is understood as follows: the aqueous coating composition in question is applied such that the coating film produced from said composition is disposed on at least part of the surface of the substrate but need not necessarily be in direct contact with the surface of the substrate. For example, between the coating film and the surface of the substrate, there may be other coats disposed. Preferably, the inventive aqueous coating composition is applied directly to at least part of the surface of the substrate in the first step, meaning that the coating film produced from applying the inventive aqueous coating composition is in direct contact with the surface of the substrate.

The inventive aqueous coating compositions may be applied by the methods known to the skilled person for applying liquid coating materials, as for example by dipping, knifecoating, spraying, rolling, brushing or the like. Preference is given to employing spray application methods, such as, for example, compressed air spraying (pneumatic application), airless spraying, high-speed rotation, electrostatic spray application (ESTA), optionally in conjunction with hot spray application such as hot air (hot spraying), or brushing. With very particular preference, the inventive radiation curable coating composition is applied via pneumatic spray application or brushing.

Despite the aqueous nature of the inventive coating composition, said coating composition can be applied in high wet film thicknesses without the formation of undesired runs, which result in an undesired optical appearance. Moreover, the high wet film thicknesses allows to achieve a good hiding power of the cured coating layer, thus avoiding repainting of the coated substrate to avoid that the color of the underlying substrate is still visible through the cured coating layer.

### Curing of the Applied Aqueous Coating Composition:

In the second step of the inventive process, the applied aqueous coating composition is cured. The aqueous coating composition possesses very short curing times at room temperature. Preferably, the aqueous coating composition, when applied onto the substrate (S) in a wet thickness of up to 60 μm, forms a cured coating layer in less than 1 minute, preferably within 10 to 40 seconds, at a temperature of 18 to 25° C. These short curing times allow extremely fast further processing of the coated substrate, for example by applying a further coating layer on parts of the substrate not yet coated with a coating layer. Thus, the short curing times of the inventive aqueous coating composition at room temperature allow an extremely efficient coating process of plastic substrates.

In one example, the applied aqueous coating composition is cured for a duration of less than 3 minutes, in particular of 10 seconds to 2 minutes, at temperatures of 18 to 40° C., preferably of 18 to 25° C. Such curing times may be preferred if the aqueous coating composition is applied in a wet film thickness of up to 60 μm.

In another example, the applied coating composition is cured for a duration of 10 to 50 minutes, in particular of 10 to 35 minutes, at temperatures of 18 to 40° C., preferably of 18 to 25° C. Such curing times may be preferred if the aqueous coating composition is applied in a wet film thickness of more than to 60 μm, for example via brushing to achieve a high hiding power of the resulting coating layer.

The dry film thickness of the cured coating layer obtained after curing may vary greatly and primarily depends on the surface roughness and/or geometry of the substrate. It may range, for example, from 5 to 200 μm, preferably from 5 to 80 μm.

### Further Method Steps:

The inventive method may further comprise a step of applying a further coating composition, such as an inventive aqueous coating composition not comprising any pigments, i.e. a clearcoat composition, onto the cured coating layer. The further aqueous coating compositions can be applied and cured as previously described. Application of a further inventive aqueous coating composition may be beneficial if a specific optical appearance of the coated substrate, such as a high gloss or a matte finish, should be achieved.

What has been said about the inventive aqueous coating composition applies mutatis mutandis with respect to further preferred embodiments of the inventive method.

### Inventive Coating

After the end of the method of the invention, the result is an inventive coating. The inventive coating shows a high adhesion to a variety of plastic substrates, such as molded TPE and PVC toys and toy parts, thus preventing splitting and peeling of the coating during the use of the substrate.

What has been said about the inventive aqueous coating composition and the inventive method applies mutatis mutandis with respect to further preferred embodiments of the inventive coating.

### Inventive Coated Substrate

A final subject of the present invention is a substrate (S) bearing an inventive coating (C). The inventive coating can be produced according to the inventive method described previously and shows a high adhesion to the underlying substrate without the use of a primer layer. Since the aqueous coating compositions used to prepare the inventive coating only contain low amounts of organic solvents and allow extremely fast curing times at room temperature, they are especially suited for plastic substrates, such as molded TPE and PVC toys and parts thereof, where strict safety regulations for the used components apply.

What has been said about the inventive aqueous coating composition, the inventive method and the inventive coating applies mutatis mutandis with respect to further preferred embodiments of the inventive coated substrate.

The invention is described in particular by the following clauses:
1. Aqueous coating composition comprising:
   (a) at least one aqueous dispersion D1 comprising a first polyurethane resin P1, said first polyurethane resin P1 having a glass transition temperature (Tg) of less than or equal to −30° C. as determined according to DIN EN ISO 11357-2 2020-08,
   (b) at least one aqueous dispersion D2 comprising a second polyurethane resin P2 being different from the first polyurethane resin P1, said second polyurethane resin P2 having a 100% Modulus of at least 1 MPa as determined according to DIN 53504:2017-03,
   (c) at least one aqueous dispersion D3 comprising a third polyurethane resin P3 being different from the first polyurethane resin P1 and the second polyurethane resin P2, said third polyurethane resin P3 having a glass transition temperature (Tg) of less than or equal to −40° C. as determined according to DIN EN ISO 11357-2-2020-08, and
   (d) at least one crosslinking agent.
2. The aqueous coating composition of clause 1, wherein the first polyurethane resin P1 has a glass transition temperature (Tg) of −30 to −50° C., preferably of −35° C. to −45° C., very preferably of −38° C. to −42° C.
3. The aqueous coating composition of clause 1 or 2, wherein the first polyurethane resin P1 is an anionic polyurethane resin.
4. The aqueous coating composition of any one of clauses 1 to 3, wherein the first polyurethane resin P1 is an aliphatic polyester-based polyurethane resin.
5. The aqueous coating composition of any one of clauses 1 to 4, wherein the first polyurethane resin P1 has an acid number of 5 to 100 mg KOH/g solids, preferably of 10 to 50 mg KOH/g solids, very preferably of 15 to 30 mg KOH/g solids.
6. The aqueous coating composition of any one of clauses 1 to 5, wherein the first polyurethane resin P1 has a hydroxyl number of 1 to 150 mg KOH/g solids, preferably of 2 to 100 mg KOH/solids, more preferably of 5 to 70 mg KOH/g solids, very preferably of 10 to 25 mg KOH/g solids.
7. The aqueous coating composition of any one of clauses 1 to 6, wherein the first polyurethane resin P1 has a number average molecular weight Mn of 750 to 2,000,000 g/mol, preferably of 1,000 to 1,000,000, more preferably of 2,000 to 500,000, very preferably of 5,000 to 10,000 g/mol.
8. The aqueous coating composition of any one of clauses 1 to 7, wherein the first polyurethane resin P1 is obtained by reacting an NCO-functional prepolymer with at least one polyol.
9. The aqueous coating composition of clause 8, wherein the equivalent ratio between the active hydrogen of the polyol and the NCO-groups of the NCO-functional prepolymer is from 2:1 to 1:2, preferably from 1.1:1 to 1:1.1.
10. The aqueous coating composition of clause 8 or 9, wherein the polyol is an aliphatic monomeric polyol, preferably an aliphatic monomeric polyol comprising at least three hydroxyl groups, in particular trimethylolpropane.
11. The aqueous coating composition of any one of clauses 8 to 10, wherein the NCO-functional prepolymer is obtained by reacting:
   at least one aliphatic polyester polyol having an OH number of 40 to 100 mg KOH/g solids and a number average molecular weight Mn of 1,000 to 3,000 g/mol,
   at least one compound comprising at least one acid group and at least one group being capable of reacting with NCO-groups,
   at least one polyol having an average molecular weight MW of 60 to 400 g/mol, and
   at least one polyisocyanate.
12. The aqueous coating composition of clause 11, wherein the aliphatic polyester polyol is obtained by reacting a dimer fatty acid with an aromatic dicarboxylic acid and a diol.
13. The aqueous coating composition of clause 11 or 12, wherein the at least one compound comprising at least one acid group and at least one group being capable of reacting with NCO-groups is selected from alkanoic acids having 3 to 8 carbon atoms and 2 hydroxy groups, in particular from dimethylol propionic acid.
14. The aqueous coating composition of any one of clauses 11 to 13, wherein the at least one polyol having an average molecular weight MW of 60 to 400 g/mol is an aliphatic polyol having 3 to 10 carbon atoms and 2 hydroxy groups, in particular neopentyl glycol.
15. The aqueous coating composition of any one of clauses 11 to 14, wherein the polyisocyanate is selected from aliphatic, cycloaliphatic, araliphatic and/or aromatic polyisocyanates, in particular from cycloaliphatic polyisocyanates.
16. The aqueous coating composition of any one of clauses 1 to 15, wherein the aqueous dispersion D1 has an average particle size (z-mean) of 30 to 200 nm, preferably of 40 to 100 nm, very preferably of 45 to 60 nm, determined according to photon correlation spectroscopy.
17. The aqueous coating composition of any one of clauses 1 to 16, wherein the aqueous dispersion D1 comprises the first polyurethane resin P1 in a total amount of 10 to 60% by weight, preferably of 15 to 50% by weight, more preferably of 20 to 40% by weight, very preferably of 25 to 35% by weight, based in each case on the total weight of the aqueous dispersion D1.
18. The aqueous coating composition of any one of clauses 1 to 17, wherein the aqueous coating composition comprises the aqueous dispersion D1 in a total amount of 5 to 60% by weight, preferably of 10 to 50% by weight, very preferably of 15 to 25% by weight, based in each case on the total weight of the aqueous coating composition.
19. The aqueous coating composition of any one of clauses 1 to 18, wherein the second polyurethane resin P2 has a 100% Modulus of 1 to 6 MPa, preferably of 1 to 4 MPa, very preferably of 1.4 to 1.9 MPa, as determined according to DIN 53504:2017-03.
20. The aqueous coating composition of any one of clauses 1 to 19, wherein the second polyurethane resin P2 has a tensile strength of 10 to 50 MPa, preferably of 15 to 40 MPa, very preferably of 22 to 28 MPa, as determined according to DIN 53504:2017-03.
21. The aqueous coating composition of any one of clauses 1 to 20, wherein the second polyurethane resin P2 has an elongation at break of 400 to 1,500%, preferably of 600 to 900%, very preferably of 720 to 780%, as determined according to DIN 53504:2017-03.
22. The aqueous coating composition of any one of clauses 1 to 21, wherein the second polyurethane resin P2 has a melting range of 150 to 300° C., preferably of 190 to 230° C.
23. The aqueous coating composition of any one of clauses 1 to 22, wherein the second polyurethane resin P2 is an anionic polyurethane resin.
24. The aqueous coating composition of any one of clauses 1 to 23, wherein the second polyurethane resin P2 is an aliphatic polycarbonate-polyether-based polyurethane resin.
25. The aqueous coating composition of any one of clauses 1 to 24, wherein the aqueous dispersion D2 comprises the second polyurethane resin P2 in a total amount of 10 to 70% by weight, preferably of 15 to 60% by weight, more preferably of 25 to 50% by weight, very preferably of 35 to 45% by weight, based in each case on the total weight of the aqueous dispersion D2.
26. The aqueous coating composition of any one of clauses 1 to 25, wherein the aqueous coating composition comprises the aqueous dispersion D2 in a total amount of 5 to 60% by weight, preferably of 10 to 50% by weight, very preferably of 20 to 35% by weight, based in each case on the total weight of the aqueous coating composition.
27. The aqueous coating composition of any one of clauses 1 to 26, wherein the third polyurethane resin P3 has a glass transition temperature (Tg) of −40 to −80° C., preferably of −40° C. to −60° C., very preferably of −42° C. to −55° C.
28. The aqueous coating composition of any one of clauses 1 to 27, wherein the third polyurethane resin P3 is an anionic polyurethane resin.
29. The aqueous coating composition of any one of clauses 1 to 28, wherein the third polyurethane resin P3 is an aliphatic polycarbonate-polyester-based polyurethane resin.
30. The aqueous coating composition of any one of clauses 1 to 29, wherein the aqueous dispersion D3 has an average particle size (z-mean) of 20 to 200 nm, preferably of 30 to 100 nm, very preferably of 40 to 80 nm, determined according to photon correlation spectroscopy.
31. The aqueous coating composition of any one of clauses 1 to 30, wherein the aqueous dispersion D3 comprises the third polyurethane resin P3 in a total amount of 10 to 60% by weight, preferably of 20 to 50% by weight, very preferably of 30 to 40% by weight, based in each case on the total weight of the aqueous dispersion D3.
32. The aqueous coating composition of any one of clauses 1 to 31, wherein the aqueous coating composition comprises the aqueous dispersion D3 in a total amount of 1 to 40% by weight, preferably of 5 to 30% by weight, very preferably of 8 to 20% by weight, based in each case on the total weight of the aqueous coating composition.
33. The aqueous coating composition of any one of clauses 1 to 32, wherein the crosslinking agent is selected from amino resins, unblocked polyisocyanates, at least partially blocked polyisocyanates, polycarbodiimides and mixtures thereof, in particular unblocked polyisocyanates.
34. The aqueous coating composition of clause 33, wherein the unblocked polyisocyanates are selected from hexamethylene diisocyanate, octamethylene diisocyanate, decamethylene diisocyanate, dodecamethylene diisocyanate, tetradecamethylene diisocyanate, trimethylhexane diisocyanate, tetra-methylhexane diisocyanate, isophorone diisocyanate (IPDI), 2-isocyanatopropylcyclohexyl isocyanate, dicyclo-hexylmethane 2,4′-diisocyanate, dicyclohexyl-methane 4,4′-diisocyanate, 1,4- or 1,3-bis(isocyanato-methyl)-cyclohexane, 1,4- or 1,3- or 1,2-diisocyanato-cyclohexane, and 2,4- or 2,6-diisocyanato-1-methyl-cyclo-hexane, the dimers and trimers thereof, and also mixtures of these polyisocyanates.
35. The aqueous coating composition of any one of clauses 1 to 34, wherein the aqueous coating composition comprises the at least one crosslinking agent in a total amount of 1 wt. % to 40 wt. % solids, preferably of 2 to 30 wt. % solids, more particularly of 6 to 12 wt. % or 15 to 25 wt. % solids, based in each case on the total weight of the aqueous coating composition.
36. The aqueous coating composition of any one of clauses 1 to 35, further comprising at least polymer being different from polyurethane resins P1 to P3, color and/or effect pigment(s), matting agents, thickening agents, dispersing agents, leveling agents, pH adjustment agents, defoaming agents, biocides, UV absorbers, crosslinking catalysts and mixtures thereof.
37. The aqueous coating composition of any one of clauses 1 to 36, wherein aqueous coating composition has a solids content of 10 to 70 wt. %, preferably 20 to 65 wt. %, in particular 35 to 55 wt. %, based in each case on the total weight of the aqueous coating composition.
38. The aqueous coating composition of any one of clauses 1 to 37, wherein the aqueous coating composition has a viscosity of 10 to 1,000 mPa*s, preferably 40 to 600 mPa*s, in particular 100 to 250 mPa*s, as determined according to DIN EN ISO 3219-1994-10.
39. The aqueous coating composition of any one of clauses 1 to 38, wherein the aqueous coating composition comprises a VOC of 10 to 100 g/L, preferably of 10 to 60 g/L.
40. A method for producing a coating (C) on a substrate (S), said method comprising a step of applying an aqueous coating composition according to any one of clauses 1 to 39 to the substrate (S) and a step of curing the applied coating composition.
41. The method according to clause 40, wherein the substrate is selected from metal substrates, plastic substrates, substrates comprising metal and plastic parts, wood or paper, in particular from plastic substrates.
42. The method according to clause 41, wherein the plastic substrate is selected from (i) thermoplastics, such as polyolefins, thermoplastic polyurethane (TPU), thermoplastic rubbers (TPE), poly(meth)acrylates (PA), polystyrene, polyvinyl chloride (PVC), polyamides, polyurethanes, polycarbonates, polylactic acid (PLA), saturated polyesters like PET (polyethylene terephthalate), ethylene-propylene-diene (EPDM), acrylonitrile-styrene-butadiene (ABS), vinyl polymers selected from halogenated polymers other than PVC, (ii) thermosets, such as phenol resins, epoxy resins, unsaturated poly ester resins, resins with furanic groups, resins with urea groups, melamine resins, poly urethane resins (PUs), (iii) mixtures of the aforementioned thermoplastics and thermosets, (iv) fiber-reinforced polymers or composites derived from the above-cited thermoplastics or thermosets; in particular from thermoplastic rubbers (TPE).
43. The method according to any one of clauses 40 to 42, wherein the aqueous coating composition when applied onto the substrate (S) in a wet thickness of up to 60 μm, forms a cured coating layer in less than 1 minute, preferably within 10 to 40 seconds, at a temperature of 18 to 25° C.
44. The method according to any one of clauses 40 to 43, wherein the applied coating composition is cured for a duration of less than 3 minutes, in particular of 10 seconds to 2 minutes, or wherein the applied coating composition is cured for a duration of 10 to 50 minutes, in particular of 10 to 35 minutes, at temperatures of 18 to 40° C., preferably of 18 to 25° C.
45. A coating produced by the method according to any one of clauses 40 to 44.
46. A substrate (S) bearing a coating (C) as claimed in clause 45.

### EXAMPLES

The present invention will now be explained in greater detail through the use of working examples, but the present invention is in no way limited to these working examples. Moreover, the terms “parts”, “%” and “ratio” in the examples denote “parts by mass”, “mass %” and “mass ratio” respectively unless otherwise indicated.

### 1. Methods of Determination

### 1.1 Solids Content (Solids, Nonvolatile Fraction)

Unless stated otherwise, the solids content (also called proportion of solids, solid-state content, proportion of nonvolatiles) was determined according to DIN EN ISO 3251: 2018-07 at 130° C.; 60 min, starting weight 1.0 g.

### 1.2 Cross-Hatch Adhesion Test

The adhesion of the cured coating layer on the substrate was determined according to the cross-hatch adhesion test. Said test was performed and evaluated according to DIN EN ISO 2409:2020-12 on a 2D plate.

### 1.3 Stability Against Water

The stability of the coated substrate was determined by fully immersing the coated substrate in tap water at room temperature for a duration of 24 hours. The coated substrate was rated as “passed”, if no visual changes of the coating could be detected after 24 hours. Otherwise, the coated substrate was rated as “failed”.

### 1.4 Abrasion Test

The abrasion resistance of the coating layer on the substrate was determined according to DIN EN ISO 20566:2021-06.

### 1.5 UV Test

The UV resistance of the coated substrates was determined by irradiating the coated substrates for 72 h with UV light according to DIN EN ISO 4892-2:2021-11. The UV resistance was evaluated by visually comparing the irradiated coated object with a coated object not being irradiated with UV light with respect to color changes.

### 2. Preparation of Different Inventive Aqueous Coating Compositions

### 2.1 Preparation of Base Component

Two different base components BC1 and BC2 were prepared by mixing the ingredients listed in Table 1.

TABLE 1
Ingredients for base components BC1 and BC2 (all amounts are given in
wt. %, based on the total weight of the respective base component)

| Ingredients | BC1 | BC2 |
|---|---|---|
| aqueous dispersion D1 ¹⁾ | 20.0 | 21.5 |
| Impranil DLV/1 ²⁾ | 25.5 | 32.3 |
| Bayhydrol UH 2648/1 ³⁾ | 12.7 | 16.2 |
| distilled water | 5.00 | 5.39 |
| Disperbyk 199 ⁴⁾ | 1.00 | 1.00 |
| aminoethanol amine | 0.75 | 0.81 |
| aqueous polyurethane dispersion 1 ⁵⁾ | 5.00 | 7.36 |
| Syloid ED 3 ⁶⁾ | 4.00 | — |
| Aerodisp WR 8520 ⁷⁾ | 3.00 | — |
| Daotan TW 6425/40 WA ⁸⁾ | 7.00 | 7.36 |
| Perapret(R) PU New ⁹⁾ | 8.25 | 8.89 |
| BYK-345 ¹⁰⁾ | 1.00 | 1.00 |
| 3 wt. % Laponite-RD in distilled water ¹¹⁾ | 6.00 | — |
| Rheovis AS S130 ¹²⁾ | 0.80 | — |

¹⁾ solid content = 25%, contains polyurethane resin P1 having a Tg of −40° C. (DIN EN ISO 11357-2 - 2020-08); prepared according to WO 92/15405 A1, pages 14 to 15, points 1.1 and 1.2;
²⁾ solid content = 40%, aqueous dispersion of anionic aliphatic polycarbonatester-polyether polyurethane resin, the anionic aliphatic polycarbonatester-polyether polyurethane has a 100% Modulus of 1.7 MPa (DIN 53504: 2017-03) (supplied by Covestro Deutschland AG);
³⁾ solid content = 34-36%, aqueous dispersion of anionic aliphatic, polyester-polycarbonate-based polyurethane resin, the anionic aliphatic polycarbonatester-polyether polyurethane has a Tg of −45° C. to −51° C. (DIN EN ISO 11357-2 - 2020-08) (supplied by Covestro Deutschland AG);
⁴⁾ VOC and solvent-free wetting and dispersing additive (supplied by BYK Chemie GmbH);
⁵⁾ solid content = 41%, prepared according to Example 1, paragraph [0057] of EP 1 861 469 B1;
⁶⁾ synthetic amorphous silica with high porosity used as matting agent (supplied by W. R. Grace & Co. - Conn.);
⁷⁾ aqueous dispersion of hydrophobic fumed silica (supplied by Evonik Operations GmbH);
⁸⁾ hydroxy functional polyurethane dispersion (supplied by Allnex);
⁹⁾ aqueous dispersion of anionic polyurethane (supplied by BASF SE);
¹⁰⁾ Silicone surfactant for aqueous coatings (supplied by BYK Chemie GmbH);
¹¹⁾ Laponite-RD (synthetic sheet silicate, supplied by BYK Chemie GmbH);
¹²⁾ supplied by BASF SE.

### 2.2 Preparation of Aqueous Coating Compositions AC1 to AC12

The inventive aqueous coating compositions AC1 to AC12 were prepared by combining the base component, optionally the respective base color component (BCC) having a VOC of less than 250 g/L and the hardener component in the mixing ratios (weight ratios) given in Table 3.

TABLE 3
Components for preparing inventive aqueous coating compositions AC1 to AC12 (all amounts are given in parts)

| | AC1 | AC2 | AC3 | AC4 | AC5 | AC6 | AC7 | AC8 | AC9 | AC10 | AC11 | AC12 |
|---|---|---|---|---|---|---|---|---|---|---|---|---|
| BC1 | 50 | 50 | 50 | 50 | 50 | 50 | 50 | 50 | — | 50 | — | 50 |
| BC2 | — | — | — | — | — | — | — | — | 50 | — | 100 | — |
| B005 ¹⁾ | 34.02 | 49.4 | 22.0 | 14.3 | 6.92 | 1.61 | 9.06 | 26.0 | — | 10.1 | — | 50 |
| B135 ²⁾ | — | — | — | — | — | — | — | 1.70 | — | — | — | — |
| N137 ³⁾ | — | — | 21.7 | — | — | — | — | — | — | — | — | — |
| B160 ⁴⁾ | 3.58 | 0.045 | — | — | — | — | — | — | — | — | — | — |
| B165 ⁵⁾ | — | — | — | — | — | 9.34 | — | 5.57 | — | — | — | — |
| B220 ⁶⁾ | 0.84 | — | — | 19.0 | 4.02 | — | — | — | — | — | — | — |
| B235 ⁷⁾ | — | — | — | 7.63 | 14.5 | 3.44 | 6.74 | — | — | — | — | — |
| B336 ⁸⁾ | — | — | — | — | — | — | — | — | — | — | — | — |
| B385 ⁹⁾ | — | — | — | — | 19.1 | 19.2 | 6.17 | 4.66 | — | — | — | — |
| B434 ¹⁰⁾ | 6.57 | 0.16 | 3.88 | 0.56 | — | — | — | — | — | — | — | — |
| B560 ¹¹⁾ | 0.62 | 0.44 | — | — | 0.29 | — | — | — | — | — | — | — |
| B610 ¹²⁾ | — | — | — | — | — | 7.97 | — | — | — | — | — | — |
| B655 ¹³⁾ | — | — | 0.80 | 2.42 | 5.13 | — | — | — | — | — | — | — |
| B880 ¹⁴⁾ | 4.37 | — | 1.64 | 6.10 | — | — | — | — | — | — | — | — |
| B955 ¹⁵⁾ | — | — | — | — | — | 8.41 | 28.0 | 12.0 | — | 39.9 | — | — |
| B994 ¹⁶⁾ | — | — | — | — | — | — | — | — | 50 | — | — | — |
| Hardener | 6 | 6 | 6 | 6 | 6 | 6 | 6 | 6 | 6 | 6 | 6 | 6 |
| component ¹⁷⁾ | | | | | | | | | | | | |

¹⁾ white pigment paste 100-B 005 (supplied by BASF Coatings GmbH)
²⁾ yellow pigment paste 100-B 135 (supplied by BASF Coatings GmbH)
³⁾ yellow pigment paste 100-B 136 (supplied by BASF Coatings GmbH)
⁴⁾ yellow pigment paste 100-B 160 (supplied by BASF Coatings GmbH)
⁵⁾ yellow pigment paste 100-B 165 (supplied by BASF Coatings GmbH)
⁶⁾ orange pigment paste 100-B 220 (supplied by BASF Coatings GmbH)
⁷⁾ orange pigment paste 100-B 235 (supplied by BASF Coatings GmbH)
⁸⁾ red pigment paste 100-B 336 (supplied by BASF Coatings GmbH)
⁹⁾ red pigment paste 100-B 385 (supplied by BASF Coatings GmbH)
¹⁰⁾ violet pigment paste 100-B 434 (supplied by BASF Coatings GmbH)
¹¹⁾ blue pigment paste 100-B 560 (supplied by BASF Coatings GmbH)
¹³⁾ green pigment paste 100-B 610 (supplied by BASF Coatings GmbH)
¹²⁾ green pigment paste 100-B 655 (supplied by BASF Coatings GmbH)
¹⁴⁾ brown pigment paste 100-B 880 (supplied by BASF Coatings GmbH)
¹⁵⁾ black pigment paste 100-B 955 (supplied by BASF Coatings GmbH)
¹⁶⁾ black pigment paste 100-B 994 (supplied by BASF Coatings GmbH)
¹⁷⁾ 100-IC 550 hardener component (contains a mixture of aliphatic polyisocyanates in organic solvent)

### 3. Production of Coated Substrates

### 3.1 Substrate

Molded thermoplastic rubber substrates (TPE substrates) and PVC substrates were produced by injecting the molten thermoplastic rubber or PVC into a 2D mold (plate form) and 3D mold (various animal forms) and hardening the injected rubber or PVC. The molded TPE substrates and PVC substrates are cleaned with a washing liquid (Lavamatic liquid, supplied by DTL-Detergentes Tecnicos, Unipessoal, Lda) for 3 to 4 minutes using an industrial laundry machine. Afterwards, the cleaned substrates were dried.

### 3.2 Coating of Substrates

### 3.2.1 Pneumatic Spray Application

The respective aqueous coating composition AC1 to AC12 was each applied directly to part of the cleaned TPE and PVC substrates prepared in point 3.1 in a one-coat system (pneumatic manual coating) in a wet film thickness of 15 to 25 micrometers and cured for 10 to 40 seconds at 18 to 25° C. Afterwards, the remaining part of the TPE and PVC substrate was coated with the respective coating composition as previously described. The film thicknesses (cured) were in each case 6-16 micrometers.

### 3.2.2 Brush Application

The respective aqueous coating composition AC1 to AC12 was each applied directly to part of the cleaned TPE and PVC substrate prepared in point 3.1 using a brush in a wet film thickness of 15 to 25 micrometers or in a wet-film thickness of more than 60 to 70 micrometers. The applied coating compositions were each cured for 1 to 2 minutes or for 15 to 30 minutes at 18 to 25° C., depending on the applied wet film thickness of the applied aqueous coating composition AC1 to AC12.

### 3.2.3 Dip Application

The cleaned TPE and PVC substrate prepared in point 3.1 was dipped into a bath containing a 1:1 or 1:2 (v/v) dilution of the respective aqueous coating composition AC1 to AC12 with water. After removing the coated substrate from the batch, excess coating composition was drained off and the coated substrates were cured for 1 to 2 minutes at 18 to 25° C.

### 4. Results

### 4.1 Visual Assessment

No running was detected upon application of aqueous coating compositions AC1 to AC12 on TPE and PVC substrates using brush application in high wet film thicknesses despite the aqueous nature of the coating compositions. Moreover, the extremely fast curing times at room temperature avoid running of applied aqueous coating compositions AC1 to AC12 on vertically oriented substrate areas. In conclusion, all coated substrates fulfil the required quality for coated toys and toy parts in terms of visual appearance.

### 4.2 Cross-Hatch Adhesion Test

No peeling or splitting of the coating layer formed from aqueous coating compositions AC1 to AC12 on TPE and PVC plate substrates was detected in the cross-hatch adhesion test. Thus, the coating layers formed from the inventive aqueous coating compositions show a high adhesion on said plastic substrates despite their aqueous nature, extremely short curing times and the absence of an adhesion promoting layer on the substrate.

### 4.3 Stability Against Water

No visual defects could be detected after fully immersing the coted TPE and PVC substrates for 24 hours in tap water. Thus, the coating layer formed from aqueous coating compositions has a sufficient stability against dissolution, avoiding undesired negative visual impacts and release of coating layer substances during use of the coated substrate. All coated TPE and PVC substrates were accordingly rated as “passed”.

### 4.4 Abrasion Resistance

All coated TPE and PVC substrates show minor or no abrasion, thus indicating a high adhesion of the coating layer on the TPE and PVC substrate despite the absence of an adhesion promoting layer and avoiding a negative impact on the visual appearance and release of coating layer substances during use of the coated substrate.

### 4.5 UV Stability

All coated TPE and PVC substrates showed a sufficient stability against UV degradation. Thus, the formed coating layers do not exhibit an undesired visual color change upon exposure of UV light and thus show a good UV light stability. This avoids degradation of the color of the coating layer over time, rendering the visual appearance of the coated substrate unpleasant.

### 5. Discussion of the Results

The examples demonstrate that the aqueous coating compositions have extremely low curing times at room temperature if applied in thin wet film thicknesses despite their aqueous nature. This allows to use them in coating processes requiring—due to existing safety regulations or environmental regulations—the use of aqueous coating material without extensively prolonging the curing times at room temperature as compared to solvent-borne coating materials. The formed coating layers show excellent adhesion on a variety of substrates despite the absence of an adhesion promoting layer as well as a good UV stability. Moreover, the aqueous coating compositions can be applied in high wet film thicknesses without the formation of runs, which result in a negative visual appearance of the coated substrate. The extremely fast curing times at room temperature allow to coat vertically oriented substrate areas without the formation of runs, thus allowing to precisely coat the respective target area irrespective of its orientation on the substrate.

1. An aqueous coating composition comprising:
(a) at least one aqueous dispersion D1 comprising a first polyurethane resin P1, said first polyurethane resin P1 having a glass transition temperature (Tg) of less than or equal to −30° C. as determined according to DIN EN ISO 11357-2-2020-08,
(b) at least one aqueous dispersion D2 comprising a second polyurethane resin P2 being different from the first polyurethane resin P1, said second polyurethane resin P2 having a 100% Modulus of at least 1 MPa as determined according to DIN 53504:2017-03,
(c) at least one aqueous dispersion D3 comprising a third polyurethane resin P3 being different from the first polyurethane resin P1 and the second polyurethane resin P2, said third polyurethane resin P3 having a glass transition temperature (Tg) of less than or equal to −40° C. as determined according to DIN EN ISO 11357-2-2020-08, and
(d) at least one crosslinking agent.

2. The aqueous coating composition of claim 1, wherein the first polyurethane resin P1 has a glass transition temperature (Tg) in a range of from −30 to −50° C.

3. The aqueous coating composition of claim 1, wherein the first polyurethane resin P1 is an aliphatic polyester-based polyurethane resin.

4. The aqueous coating composition of claim 1, wherein the aqueous coating composition comprises the aqueous dispersion D1 in a total amount in a range of from 5 to 60% by weight, based on the total weight of the aqueous coating composition.

5. The aqueous coating composition of claim 1, wherein the second polyurethane resin P2 has a 100% Modulus in a range of from 1 to 6 MPa as determined according to DIN 53504.2017-03.

6. The aqueous coating composition of claim 1, wherein the second polyurethane resin P2 has a tensile strength in a range of from 10 to 50 MPa as determined according to DIN 53504.2017-03.

7. The aqueous coating composition of claim 1, wherein the second polyurethane resin P2 is an aliphatic polycarbonate-polyether-based polyurethane resin.

8. The aqueous coating composition of claim 1, wherein the aqueous coating composition comprises the aqueous dispersion D2 in a total amount in a range of from 5 to 60% by weight based on the total weight of the aqueous coating composition.

9. The aqueous coating composition of claim 1, wherein the third polyurethane resin P3 has a glass transition temperature (Tg) in a range of from −40 to −80° C.

10. The aqueous coating composition of claim 1, wherein the third polyurethane resin P3 is an aliphatic polycarbonate-polyester-based polyurethane resin.

11. The aqueous coating composition of claim 1, wherein the aqueous coating composition comprises the aqueous dispersion D3 in a total amount in a range of from 1 to 40% by weight based on the total weight of the aqueous coating composition.

12. The aqueous coating composition of claim 1, wherein the aqueous coating composition comprises a VOC of 10 to 100 g/L.

13. A method for producing a coating (C) on a substrate (S), said method comprising a step of applying the aqueous coating composition according to claim 1 to the substrate (S) and a step of curing the applied coating composition.

14. A coating Q produced by the method according to claim 13.

15. A substrate (S) bearing the coating (C) of claim 14.

16. The aqueous coating composition of claim 1, wherein the first polyurethane resin P1 has a glass transition temperature (Tg) in a range of from −35 to −45° C.

17. The aqueous coating composition of claim 1, wherein the first polyurethane resin P1 has a glass transition temperature (Tg) in a range of from −38 to −42° C.

18. The aqueous coating composition of claim 1, wherein the aqueous coating composition comprises the aqueous dispersion D1 in a total amount in a range of from 10 to 50% by weight based on the total weight of the aqueous coating composition.

19. The aqueous coating composition of claim 1, wherein the aqueous coating composition comprises the aqueous dispersion D1 in a total amount in a range of from 15 to 25% by weight based on the total weight of the aqueous coating composition.

20. The aqueous coating composition of claim 1, wherein the second polyurethane resin P2 has a 100% Modulus in a range of from 1 to 4 MPa as determined according to DIN 53504:2017-03.
